(19) United States
(12) Patent Application Publication
(10) Pub. No.: US 2026/0253431 A1
(43) Pub. Date: Aug. 27, 2026

(54) DEVICES AND METHODS FOR BIVALVE HARVEST OPTIMISATION

(71) Applicant: Harvest Hub Limited, Nelson (NZ)

(72) Inventors: Crispin David LOVELL-SMITH, Nelson (NZ); Julian Roscoe MACLAREN, Nelson (NZ); Nicola Ann HAWES, Nelson (NZ); Reno Harley Bolstad HOLMES, Nelson (NZ)

(21) Appl. No.: 18/881,981

(22) PCT Filed: Sep. 8, 2023
(86) PCT No.: PCT/NZ2023/050093

§ 371 Date: Jan. 7, 2025

(30) Foreign Application Priority Data
Jul. 8, 2022 (NZ) 790159

(51) Int. Cl. G06V 20/68; G06N 3/09; G06T 7/00; G06V 10/10

(52) U.S. Cl. CPC G06V 20/68; G06N 3/09; G06T 7/0012; G06V 10/17; G06T 2200/24; G06T 2207/10016; G06T 2207/20081; G06T 2207/20221; G06T 2207/30204

(57) ABSTRACT

A method comprising: obtaining one or more photographs of a bivalve; and determining, based on the one or more photographs, one or more metrics associated with the bivalve. The one or more photographs may be provided as an input to a trained model that provides output in the form of metrics that may relate to readiness for harvest.

### FIELD

This relates to devices and methods for bivalve harvest optimization.

### BACKGROUND

Bivalves, including mussels, oysters, scallops, and clams, are harvested for consumption or other use. In some cases, they may be wild caught, but in other cases they may be farmed. When farmed, this may occur on one or more dropper lines. When the bivalves are mature, they can then be harvested. Harvesting bivalves before they are mature may result in decreased yield or quality.

### SUMMARY

In a first example, there is provided a method comprising: obtaining one or more photographs of a bivalve; and determining, based on the one or more photographs, one or more metrics associated with the bivalve.

Further examples are set out in the claims.

### BRIEF DESCRIPTION

The description is framed by way of example with reference to the drawings which show certain embodiments. However, these drawings are provided for illustration only, and do not exhaustively set out all embodiments.

FIG. 1 shows an example method for optimizing bivalve harvest.

FIG. 2 shows an example approach for obtaining one or more photographs of a bivalve.

FIG. 3 shows a first example method for processing one or more photographs.

FIG. 4 shows a second example method of processing one or more photographs.

FIG. 5 shows an example system.

FIG. 6 shows a first example tray.

FIG. 7 shows a second example tray comprising indicia.

### DETAILED DESCRIPTION

In an embodiment, there is provided an approach for optimizing bivalve harvest. Optimizing does not necessarily mean obtaining an optimal outcome. Instead, optimizing means providing a potentially improved outcome compared to conventional human approaches.

FIG. 1 shows an example method for optimizing bivalve harvest.

At step 110, the system obtains one or more photographs of each of one or more bivalves.

The bivalves may be obtained as part of a sampling approach. For example, the bivalves may comprise one or more bivalves from each of one or more dropper lines. In a further example, the bivalves are obtained from a range of areas of dropper line, for example from the top, middle, and bottom of each dropper line.

The bivalves may be raw or cooked. For a given species or implementation, one approach may provide a higher quality output which can be identified during calibration of the system.

The one or more photographs may be obtained in accordance with the method shown in FIG. 2.

At step 120, the system processes the one or more photographs.

The processing may comprise transforming the photographs in a manner to improve their use for subsequent input. As a result, the photographs are output in a relatively standardized comparable format.

The processing may occur in accordance with the method shown in FIG. 3 or 4.

At step 130, the one or more photographs is provided as an input to a trained model.

The trained models are configured to receive an input comprising imagery (such as photographs) of a bivalve and provide an output. The appropriate trained model is selected based on the desired output. Examples of how the model may be trained are described below.

At step 140, the trained model provides an output.

In some cases, the output may be data, and may comprise one or more metrics. The metrics may relate to readiness for harvest.

In a first example, a metric may be a condition score. The condition score indicates the readiness to harvest. This may be calculated in the manner shown in FIG. 2. Based on the condition score, this may indicate whether the bivalves are ready for harvest. In cases where the photographed bivalves are a sample, this may indicate that the entire dropper line or farm is ready for harvest.

In a second example, a metric may be a biofouling score. The biofouling score indicates the amount of the bivalve affected by another species. In some cases, the other species may be one or more invasive species identified by a list of invasive species. The list of invasive species may be provided by a government department, a regulator, or another entity. Based on the biofouling score, this may indicate that some intervention is required to reduce the amount of biofouling.

In a third example, a metric may be one or more measurements of the bivalve. For example, this may comprise one or more of a sex, length, width, thickness, shell volume, shell damage, meat pigmentation, and meat-to-shell ratio. Based on these, this may indicate whether the bivalves are ready for harvest. In cases where the photographed bivalves are a sample, this may indicate that the entire dropper line or farm is ready for harvest. Additionally or alternatively, this may indicate the suitability of the bivalve for breeding.

In some cases, the metrics may further be used to indicate the suitability of the bivalve (or genetically related bivalves) for breeding. Where the preceding steps are not destructive (for example, the bivalve is not opened), the same bivalve that is photographed might be suitable for breeding. In a more general case, such as where the bivalve is opened, this indication may relate to other individuals of the same family might be suitable for breeding. This could then form part of a selective breeding programme.

The output may be displayed to a user, for example on a user interface on a mobile device.

In some embodiments, the output may be provided to control one of more apparatus.

In a first example, the output may be an instruction to a harvesting apparatus. The harvesting apparatus may determine, based on the output, whether or not to harvest the bivalves.

In a second example, the output may be an instruction to a sampling system. The sampling system may determine, based on the output, whether or not to continue sampling the bivalves.

In a third example, the output may be an instruction to a processing system. The processing system may determine, based on the output, how to process the bivalves which are harvested. For example, bivalves with certain characteristics may be used for oil, whereas bivalves with other characteristics may be used as meat.

This provides an optimized approach for the harvest of bivalves which may result in improved yield and/or quality compared with conventional approaches.

### Photographs

FIG. 2 shows an example approach for obtaining one or more photographs of a bivalve. FIG. 2 may occur using a system comprising a camera. In some cases, the system may be a mobile device such as a smartphone.

At step 210, the bivalve is opened. This results in the meat of the bivalve remaining attached to one half of the shell. The other half of the shell is typically free of meat, and therefore empty.

At step 220, the bivalve is located on a tray.

The purpose of the tray may be to at least hold the bivalves in place. In preferred embodiments, the bivalves are located such that the meat-containing shell is located face up on the tray and the empty shell is located face down on the tray. In this way, both shells are on the same tray.

Examples of such trays, and their usage, are shown in FIG. 6 or 7.

At step 230, the system determines that the camera is in the appropriate position. This may be based on whether the entire tray is in the field of view of the camera and/or whether sufficient lighting is provided.

When the entire tray is not in the field of view of the camera, the system may provide feedback to an operator to adjust the camera and/or the tray, or may adjust the camera and/or the tray automatically. When sufficient lighting is not provided, the system may provide feedback to an operator to adjust the lighting or may adjust the lighting automatically.

In some cases, step 230 may be omitted, for example where precise positioning is not necessary.

At step 240, a camera takes one or more photographs of the tray.

The one or more photographs of the tray may comprise still photographs and/or a video.

The one or more photographs may be taken from different positions. This may be from multiple cameras which take photographs from different positions and/or from one or more cameras which move location.

The one or more photographs may be taken with a time delay between each photograph. In a preferred embodiment, this is about 1/10 of a second. This results in images that show the tray in slightly different positions over time.

The one or more photographs may be taken with different lighting conditions. This may occur as the result of alternating the lighting providing by a lighting module of the system. For example, this may comprise turning on or off illumination and/or changing the colour of the illumination between white, red, infrared, or other colours.

In a second example, the photographs may comprise LIDAR (“light detection and ranging”) images of the tray. This may allow for improve geometry of the bivalve.

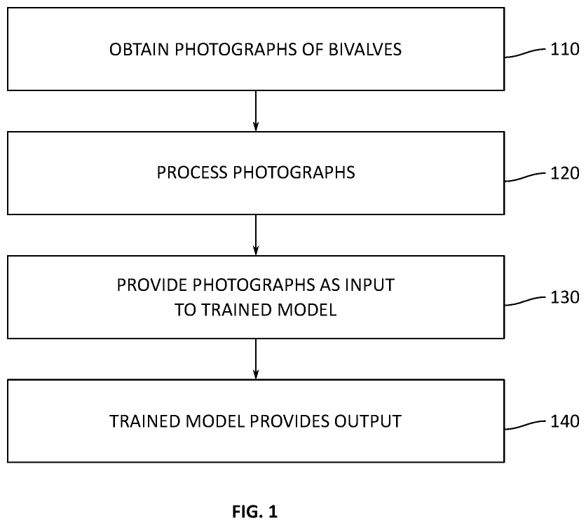

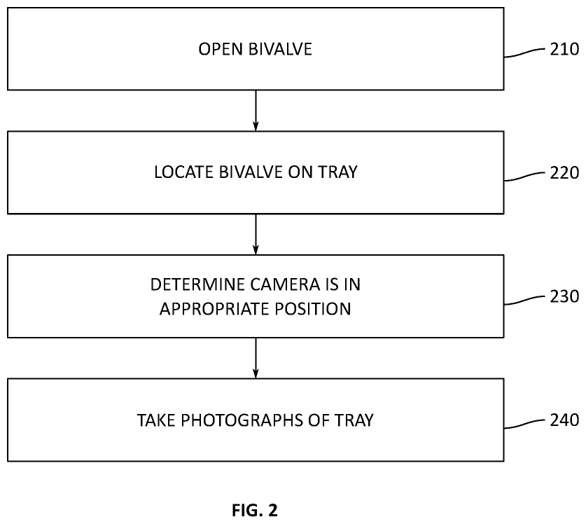

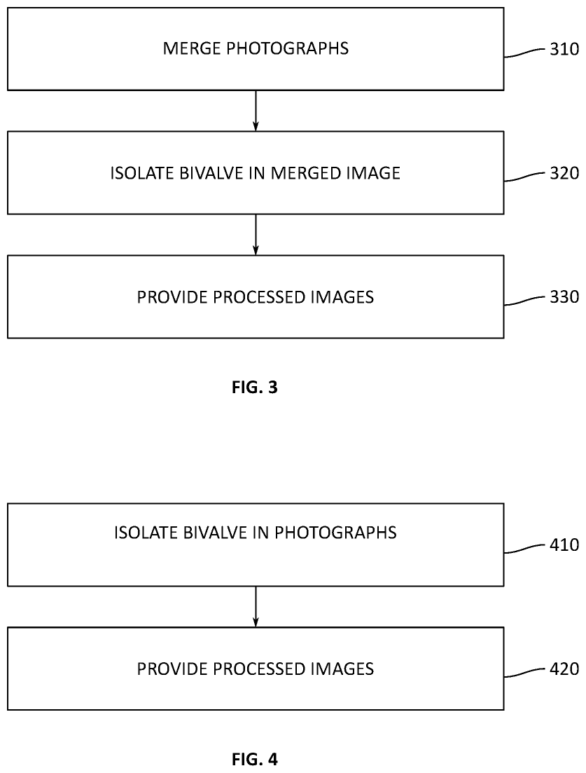

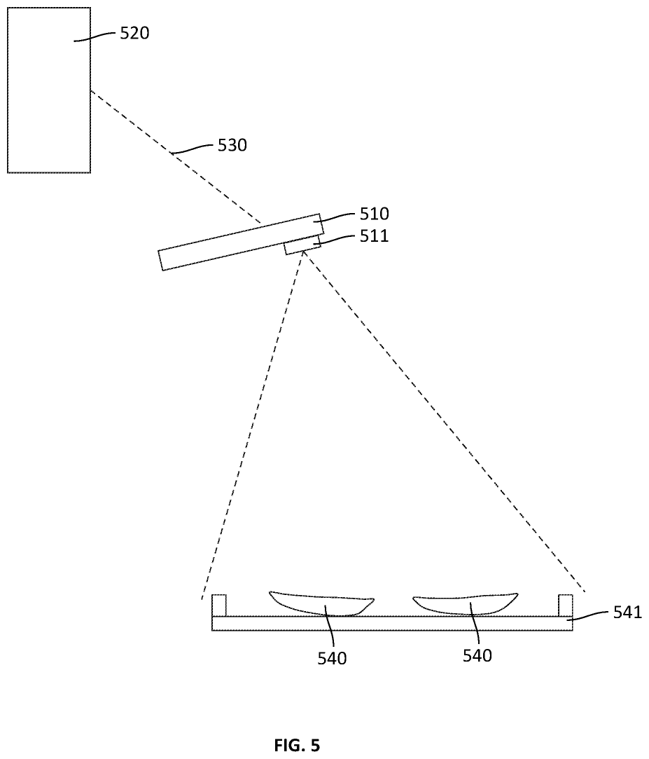

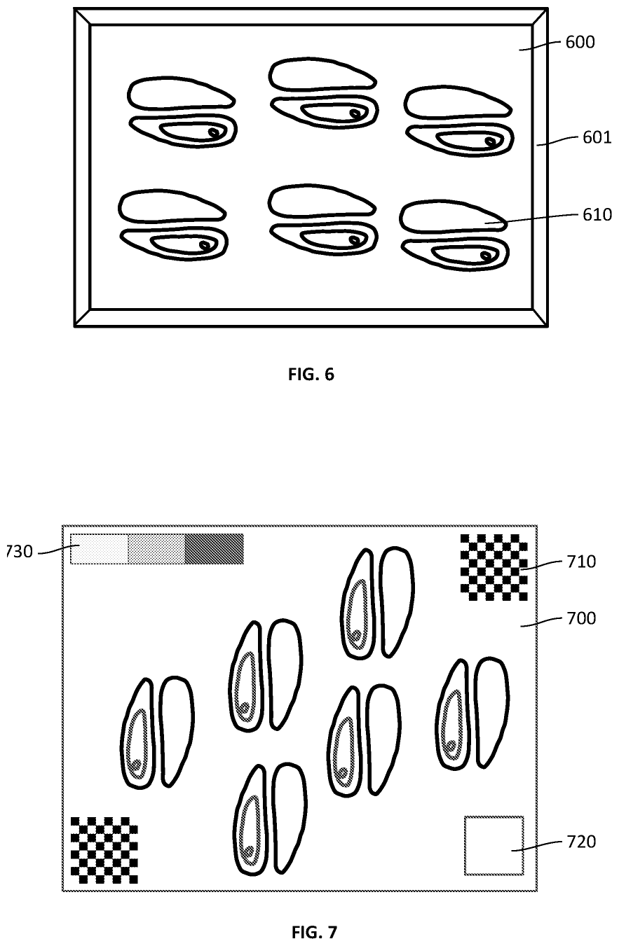

As the result of the method of FIG. 2, one or more photographs of the bivalve are provided.

### Processing Photographs

FIG. 3 shows a first example method for processing one or more photographs.

At step 310, a plurality of photographs is merged to obtain a merged image. The plurality of photographs relate to the same bivalve. The merger may occur on the basis of indicia on a tray in the photograph. Additionally or alternatively, the merger may occur on the basis of scale invariant feature transformation (SIFT) features.

The merger may reduce or eliminate reflections. For example, where the plurality of photographs comprise photographs of substantially the same content from different positions, each photograph will tend to have reflection (if any) at a different part of the photograph. By combining these appropriately, the reflection may be eliminated in the merged image. This may be particularly beneficial in use, as the environment in which bivalves are harvested is typically wet, which increases the likelihood of reflection.

At step 320, the bivalve within the merged image is isolated. In this case, isolating may mean providing cropped photographs in which features other than the bivalve are omitted.

In some cases, this may occur through semantic segmentation. The semantic segmentation may occur through the use of a trained model, for example a convolutional neural network such as a U-Net. In some cases, different parts of the bivalve may be isolated. For example, the meat and shell may be isolated.

At step 330, one or more processed images are provided. These may then be used for further analysis.

FIG. 4 shows a second example method of processing one or more photographs.

At step 410, the bivalve within each of one or more photographs is isolated. In this case, isolating may mean providing cropped photographs in which features other than the bivalve are omitted.

In some cases, this may occur through semantic segmentation. The semantic segmentation may occur through the use of a trained model, for example a convolutional neural network such as a U-Net. In some cases, different parts of the bivalve may be isolated. For example, the meat and shell may be isolated.

At step 420, one or more processed images are provided. These may then be used for further analysis. FIG. 4 therefore differs from FIG. 3 in that no merger occurs so that multiple images of the same bivalve are obtained.

### Training the Model

At step 130 noted above, one or more photographs are provided as an input to a trained model. There are multiple approaches for training an appropriate model, based on the preferred output.

In a first example, a model is trained for use in calculating a condition score. A condition score indicates the readiness of the bivalve for harvest. A training set is provided where images of a shell containing meat are provided along with a condition score. In one case, the condition score in the training set is based on the meat-to-shell ratio, obtained through cooking and weighing bivalves in the training set. In another case, the condition score in the training set is based on scores provided by human evaluators.

In a second example, a model is trained for use in calculating a biofouling score. The biofouling score indicates the amount of the bivalve affected by another species. In some cases, the other species may be one or more invasive species identified by a list of invasive species. The list of invasive species may be provided by a government department, a regulator, or another entity. A training set is provided where images of an empty shell are provided along with a biofouling score. The biofouling score in the training set may be based on weighing the amount of other species.

In a third example, a model is trained for use in calculating parameters relating to the meat of a bivalve based on its outer appearance. The parameters may comprise condition score. A training set is provided where images of the outside of a shell are provided along with determined parameters.

Further models may be provided for various parameters of the bivalves, such as sex, length, width, thickness, shell damage, meat pigmentation, and meat-to-shell ratio.

The bivalves in the training set may be exclusively raw, exclusively cooked, or a mixture. In some embodiments, the training set includes both data relating to the same bivalve individual in both a raw and a cooked state. This can provide additional ground truth data and additional consistency checks over time. In addition, this may allow properties of a cooked bivalve to be derived from photographs of a raw bivalve (and vice versa).

Training the models uses artificial intelligence techniques. In preferred embodiments, supervising training of a neural network is used.

### System

FIG. 5 shows an example system for performing the methods noted above.

In the system, edge device 510 (such as a smart phone) may be provided, in use, proximate the bivalves 540 on a tray 541. Edge device 510 may comprise one or more cameras 511.

The edge device 510 is configured to perform the method of FIG. 1, steps 230 and 240 of FIG. 2, FIG. 3, and FIG. 4 through an app. That is, the edge device 510 can preferentially perform all steps other than training models. This may be useful in cases where network access is limited: the edge device 510 can perform the necessary analysis in real-time to enable sampling on site.

Server 520 is accessible by the edge device 510 via network 530 (such as the Internet). In use, edge device 510 sends data to the server 520 when the network 530 is available. This may occur substantially after processing occurs by the edge device 530. This enables record keeping at server 520, for example via farm management applications.

### Tray

As described above, bivalves may be located on a tray when photographs are taken.

FIG. 6 shows a first example tray 600 which may be used for this purpose.

Tray 600 comprises a substantially flat surface onto which the bivalves 610. This may provide a reference point for subsequent photographs to allow the photographs to be comparable, despite non-standardised cameras. The tray may be made of a robust and/or waterproof material, such as plastic. The substantially flat surface may be bounded by walls 601 to reduce the chance of a shell falling off the tray 600 in use.

FIG. 7 shows a second example tray 700, which is the same as the tray 600 with the addition of one or more indicia.

In a first example, the indicia may comprise a regular geometric pattern 710, such as a checkerboard. This may aid in providing known geometry, such as corner points or other reference points.

In a second example, the indicia may comprise a fiducial marker 720, such as a quick response (QR) code. The fiducial marker may encode or correspond to one or more of a location of harvest and/or a time of harvest.

In a third example, the indicia may comprise a colour chart 730. The colour chart, optionally in conjunction with a white background, may allow for colour correction purposes, in order to accurately account for differences in camera image sensor properties and camera settings. For example, in the case of a mussels, a creamy white colour in a male or a bright orange colour in a female indicates that the mussel is ready for harvest.

The indicia may be duplicated and distributed across the tray. This reduces the chance that a located bivalve obscures the indicia.

In some cases, the indicia may be printed directly on the tray. In other cases, the indicia may be separate pieces, such as printed card or other material which can be placed or attached to the tray.

### Interpretation

A number of methods have been described above. Any of these methods may be embodied in a series of instructions, which may form a computer program. These instructions, or this computer program, may be stored on a computer readable medium, which may be non-transitory. When executed, these instructions or this program cause a processor to perform the described methods.

The steps of the methods have been described in a particular order for ease of understanding. However, the steps can be performed in a different order from that specified, or with steps being performed in parallel. This is the case in all methods except where one step is dependent on another having been performed.

The term “comprises” and other grammatical forms is intended to have an inclusive meaning unless otherwise noted. That is, they should be taken to mean an inclusion of the listed components, and possibly of other non-specified components or elements.

While the present invention has been explained by the description of certain embodiments, the invention is not restricted to these embodiments. It is possible to modify these embodiments without departing from the spirit or scope of the invention.

1. A method comprising:
obtaining one or more photographs of a bivalve; and
determining, based on the one or more photographs, one or more metrics associated with the bivalve.

2. The method of claim 1, further comprising:
locating the bivalve on a surface of known geometry.

3. The method of claim 2, where the known geometry is flat.

4. (canceled)

5. The method of claim 2, wherein the surface comprises one or more indicia and wherein the indicia comprises one or more of:
a regular geometric pattern;
a fiducial marker; and
a colour chart.

6. The method of claim 2, wherein locating the bivalve on a surface of known geometry comprises:
locating the half of the bivalve containing meat face up; and
locating the other half of the bivalve face down.

7. The method of claim 6, wherein the bivalve is cooked.

8. The method of claim 1, wherein obtaining one or more photographs of a bivalve comprises:
using a camera of a mobile device to obtain one or more photographs of a bivalve.

9. The method of claim 8, wherein obtaining one or more photographs of a bivalve comprises:
obtaining a plurality of photographs of the bivalve, where in the photographs differ in a location and/or a time.

10. The method of claim 1, wherein obtaining one or more photographs of a bivalve comprises:
obtaining a video of the bivalve.

11. The method of claim 1, wherein the metrics comprise one or more of:
a condition score indicating the readiness to harvest;
a biofouling score indicating the amount of the bivalve affected by another species;
sex;
length;
width;
thickness;
shell volume;
shell damage;
meat pigmentation; and
meat-to-shell ratio.

12. (canceled)

13. The method of claim 1, further comprising:
processing the one or more photographs, wherein processing the one or more photographs comprises:
applying semantic segmentation to the one or more photographs.

14. The method of claim 13 wherein processing the one or more photographs comprises:
merging two or more photographs to form a merged image.

15. The method of claim 1, wherein determining, based on the one or more photographs, one or more metrics associated with the bivalve comprises:
providing the one or more photographs as an input to a trained model; and
obtaining the one or more metrics as an output from the trained model.

16. The method of claim 1, further comprising:
displaying the one or more metrics on a user interface.

17. A system configured to perform the method of claim 1.

18. The system of claim 17, wherein the system is a mobile device.

19. The method of claim 1, further comprising:
locating the bivalve on a surface of known geometry, wherein the surface comprises one or more indicia, wherein the indicia comprises one or more of:
a regular geometric pattern;
a fiducial marker; and
a colour chart, and
processing the one or more photographs, wherein processing the one or more photographs comprises:
applying semantic segmentation to the one or more photographs.

20. The method of claim 19, wherein the metrics comprise one or more of:
a condition score indicating the readiness to harvest;
a biofouling score indicating the amount of the bivalve affected by another species;
sex;
length;
width;
thickness;
shell volume;
shell damage;
meat pigmentation; and
meat-to-shell ratio.

21. The method of claim 19, wherein determining, based on the one or more photographs, one or more metrics associated with the bivalve comprises:
providing the one or more photographs as an input to a trained model; and
obtaining the one or more metrics as an output from the trained model.

22. The method of claim 20, wherein determining, based on the one or more photographs, one or more metrics associated with the bivalve comprises:
providing the one or more photographs as an input to a trained model; and
obtaining the one or more metrics as an output from the trained model.
